(19) United States
(12) Patent Application Publication
(10) Pub. No.: US 2008/0168626 A1
(43) Pub. Date: Jul. 17, 2008

(54) Sportsmen's tool kit and method

(76) Inventor: James A. Sewell, Dawsonville, GA (US)

Correspondence Address: Vincent T. Kung, Esq., 8560 Parker Place, Roswell, GA, 30076, US

(21) Appl. No.: 12/077,752

(22) Filed: Mar. 21, 2008

Related U.S. Application Data
(62) Division of application No. 11/109,356, filed on Apr. 19, 2005, now abandoned.
(60) Provisional application No. 60/563,150, filed on Apr. 19, 2004.

(51) Int. Cl. B25G 1/00

(52) U.S. Cl. 16/427

(57) ABSTRACT

An assembly containing a number of different tools that can be mounted to a lightweight extension pole or rod is provided. The assembly can be integrated with hunting, camping or fishing gear, and enable sportsmen to extend their reach when performing a variety of functions. The extension pole can be a single shaft or be assembled from a number of shaft segments, each having the dimensions and physical properties of a hunting arrow shaft. With plural shaft segments, each has an upper and a lower extremity, and each has a attachment mechanism or connector for securing the individual secondary shaft segments to each other longitudinally by engaging corresponding connectors.

### CLAIM OF PRIORITY

The present Application claims benefit of priority from U.S. Provisional Application No. 60/563,150, filed, Apr. 19, 2004, and U.S. patent application Ser. No. 11/109,356, filed on Apr. 19, 2005, the content of each is incorporated herein by reference.

### FIELD OF INVENTION

The present invention relates to a tool kit assembly that sportsmen, hunters, and other people who work or play outdoors will find useful. More particular, the invention relates to an extension-mounted device for picking up and carrying objects, field dressing, or trimming or pruning foliage from bushes, small tree limbs and other vegetation from a distance, among other uses.

### BACKGROUND

Sportsmen often need to use a number of different tools. For instance, one may need to adjust or alter their surroundings, such as, when preparing a camping or hunting site in fields or woods. They may need to trim the vegetation that surrounds their campsites, hunting blinds, etc. For both gun and bow hunters, but especially bow hunters, who typically take a perch on platforms mounted in trees, a misplaced bush or tree limb can prevent one from making a shot. That is, often a good shot can be missed because of an obstruction by an unfortunately placed tree limb or bush branch. This can be a source of great frustration to the hunter.

Often in such situations, avid hunters, who tend to carry a standard set of pruning shears, saw, and/or ax, may decide to cut down an entire tree to clear a shooting lane. This can be both environmentally damaging and a waste to the property upon which the hunters hunt. Another problem hunters have is leaving scent marks on the foliage that they cut, since there is no means of using these tools from a distance in an extendable manner, without getting close to the vegetation. Sometimes, the hunter may use a conventional pole-mounted trimmer, such as gardeners and forestry workers commonly use, to prune the surrounding vegetation beforehand from the ground. Often, however, this is rather impractical. First, one can only accurately determine the correct sight lines and shooting alleys from the perspective of the perch on high. Second, once the hunter is situated in his perch, it can be rather cumbersome if not dangerous to operate a conventional pole-mounted trimmer. Conventional pole-mounted trimmers typically tend to be rather heavy and bulky. Trimmers of this type, consist of a cutting tool or a blade, like that of a scythe, mounted on one end of a wooden, aluminum, or other metal-based shaft of several feet or meters in length, with a shaft diameter of at least a few inches (e.g., at least ˜4-5 cm) and a circumference of several inches (e.g., at least ˜14-16 cm); hence, requiring a degree of balance to operate. In other words, to operate such a trimmer, especially the long or large versions, the user needs to have a rather wide and steady base in order to balance the heavy shaft and cutting end on the pole. In the case of bow huntsmen, who are seated on generally narrow shooting platforms high in the trees, this can be both rather unwieldy to use and dangerous for fear of loosing balance and falling.

After a game animal is taken, the animal is typically field-dressed, which involves opening the body cavity of the animal and removing the internal organs. With larger game, such as deer or elk, this process can be rather messy. Often the hunter will need to bury his upper body in the animal carcass to reach areas such as the upper chest and neck. A tool that can extend the reach of the hunter for dressing, while avoiding the need to get physically into the animal's body cavity would be well appreciated.

Furthermore, in the case of fishermen for example, no tool at present exists to help them untangle their lures and lines when the fishing lines get caught or entangled in either overhead branches on land, which can not be easily reached, or submerged snags in shallow water, which can not be closely approached.

At present, it is believed, that no single device or kit exists on the market that can enable sportsmen of all types to prepare camping or hunting sites, field dress animals, or retrieve fishing lines and lures. As a result of some of these shortcomings, for those in the hunting and outdoors industry, a need exists for an all in one assembly kit or device that will enable a hunters to prune or cut back the foliage on limbs or branches of bushes and trees from an elevated position for the purpose of creating an unobstructed shooting lane, as well as perform a variety of other functions, as will be described. The new kit or device should be light, not bulky, flexible, and easy to assemble and disassemble in the field. The present invention satisfied these criteria and is both cost effective to make and economic in the hunting and/or horticultural and gardening equipment markets.

### SUMMARY OF THE INVENTION

The present invention pertains to an assembly or utility kit that includes an extension rod or pole and a number of extension-mountable tools or devices. The assemblage is adapted to be relatively light-weight and portably compact, making it convenient to carry or be included as part of outdoorsmen's equipment, such as in either camping, fishing, or hunting gear.

Generally, the kit assembly includes a number of slender shaft segments that can be joined together to form a longer extension rod, and a set of at least one tool that is mountable to an end of the rod. The tools should be adapted to mount stably to an end of the extension rod. Depending on the desired use, the assembly can include a variety of different kinds of tools. A user can quickly assemble the extension shaft to have a tool, such as a pruning clipper, saw, knife, pincers or tongs, pliers, hook(s), grapple/grapnel, or scooper/ladle attached to one end of the extension shaft and operated remotely by means of tether lines, levers, handgrips, pulleys, or other mechanical control systems. Embodiments with a hollow or partially hollow core can be configured to have a recess, such as at either end, that can receive an end cap insert or an adaptor for engaging with a tool or having some other utility. It is desirable that the shaft of the extension rod be both lightweight for easy transport, and able to flex but not break when subjected to a force or load in use.

Some common uses in which the present extension-mountable device may be handy may include camping, hunting, fishing, or gardening applications, for instance, that involve trimming vegetation, cleaning or field dressing an animal, avoidance of leaving human sent markings, retrieving fishing lines and lures, and carrying or retrieving gear.

The invention also pertains to a method of providing a multipurpose tool. The method involves providing a lightweight extension rod or shaft having a length greater than its width, with an upper and a lower extremity, attaching a tool adapted for cutting or trimming foliage or vegetation, field-dressing game, picking up an object, or collecting a liquid to the upper extremity of the extension rod or shaft, and providing instructions on how to use said tool to a user. The extension shaft is formed from a substantially rigid material that can flex without breaking.

Additional features and advantages of the present invention will be disclosed in the following detailed description and the accompanying illustrative drawings. It is understood that both the foregoing summary and the following detailed description and examples are merely representative of the invention, and are intended to provide an overview for understanding the invention as claimed.

### BRIEF DESCRIPTION OF FIGURES

FIG. 1 is a representation of a collection of components for an extension-mounted cutting tool, which can be included as part of a kit or assembly according to the present invention.

FIG. 1A illustrates how the several items shown in FIG. 1 can be compactly stored in a pouch.

FIG. 2 shows a clipper that is configured to attach easily to a rod according to the present invention.

FIGS. 3 and 3A are two views of a retractable saw that can be configured to attach to a rod according to the present invention. FIG. 3A shows the saw in a retracted position for ease of storage and transport.

FIG. 4 illustrates the various components of the present invention assembled together with a ratcheting pruning clipper attached.

FIG. 5 illustrates a variation of the assembly in FIG. 4, with a pruning saw attached.

FIG. 6 is a representation of an arrow quiver, having a number of slots, which can be adapted to hold the extension rods of the present invention.

FIG. 7 is an enlarged and exploded perspective view of an extension shaft having two segments according to an embodiment of the invention.

FIG. 8 is a partial cross-sectional view of the extension shaft according to FIG. 7, illustrating one type of detent mechanism and one type of end cap for use therewith.

FIG. 9 is a partial cross-sectional view of the extension shaft according to an alternative embodiment of the invention, illustrating an additional detent mechanism and end cap with knurled exterior.

FIG. 10 is a partial cross-sectional view of the extension shaft according to a further alternative embodiment of the invention, illustrating an additional detent mechanism and sooth end cap, which may function as a rubberized stopper.

FIG. 11 is a partial cross-sectional view of the extension shaft according to yet another embodiment of the invention with an arrow knock end cap.

### DETAILED DESCRIPTION OF THE INVENTION

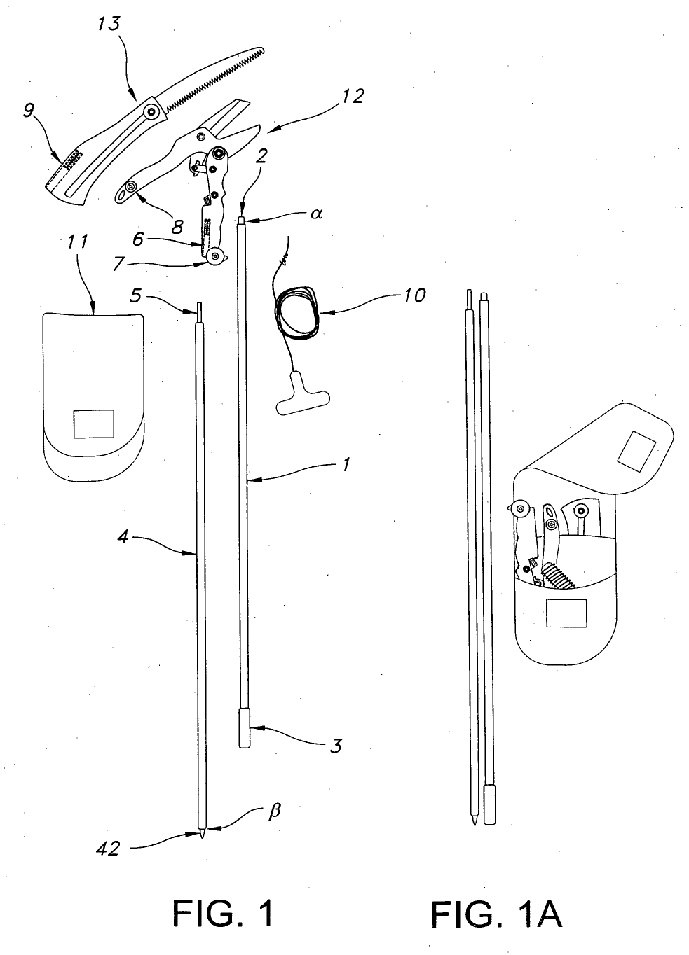

The present invention encompasses a kit or assembly that may be put together to create an extension-mounted tool for use in a variety of applications, such as trimming vegetation, field-dressing, lifting or angling, or as a fishing line retiever. According to an embodiment, such as illustrated in FIG. 1, a kit can comprise a number of light-weight, slender rods or shafts 1, 4, that when assembled form an extension pole or rod for a cutting tool such as a clipper 12 or saw 13. A tether line 10 may be included for some variations to operate the clipper, and along with a storage pouch or case. As used herein, the terms “shaft segments” or “rod members” refer to the component sections of a “pole,” “rod,” “extension pole,” or “extension rod,” which refer to the overall assembled article comprised of a number of shaft segments or rod members.

In each kit assembly, the individual extension shaft segments all may be of the same length and width or diameter. Alternatively, an assortment of different lengths and widths can be included, as long as the variable width shaft segments are adapted or tapered to be able to engage or join end-to-end with other shaft segments of narrower or wider width. This feature enables a user to choose the manner in which to configure the extension rod, with a combination of differing shaft lengths and widths.

To construct the larger extension rod 21, at least a first 1 and a second 4 shaft segments, each segment having a first and second end are fitted together. The second end 3 of the first segment is adapted to align and connect with the first end 5 of the second segment. The first end 2 of the first segment has a first or α adaptor for engaging with the tool, and the second end of the second segment has a second or β adaptor for engaging with a terminal insert or end cap 42. Each of the segments can range in length from a few inches up to about three or four feet. The shaft has a length that is substantially greater than its width, for instance, about a 1:10 or 1:25 ratio of width to length. In desirable embodiments, the ratio is about 1:30 up to about 1:100. In more typical embodiments, the ratio is about 1:50 up to about 1:75 or 1:96.

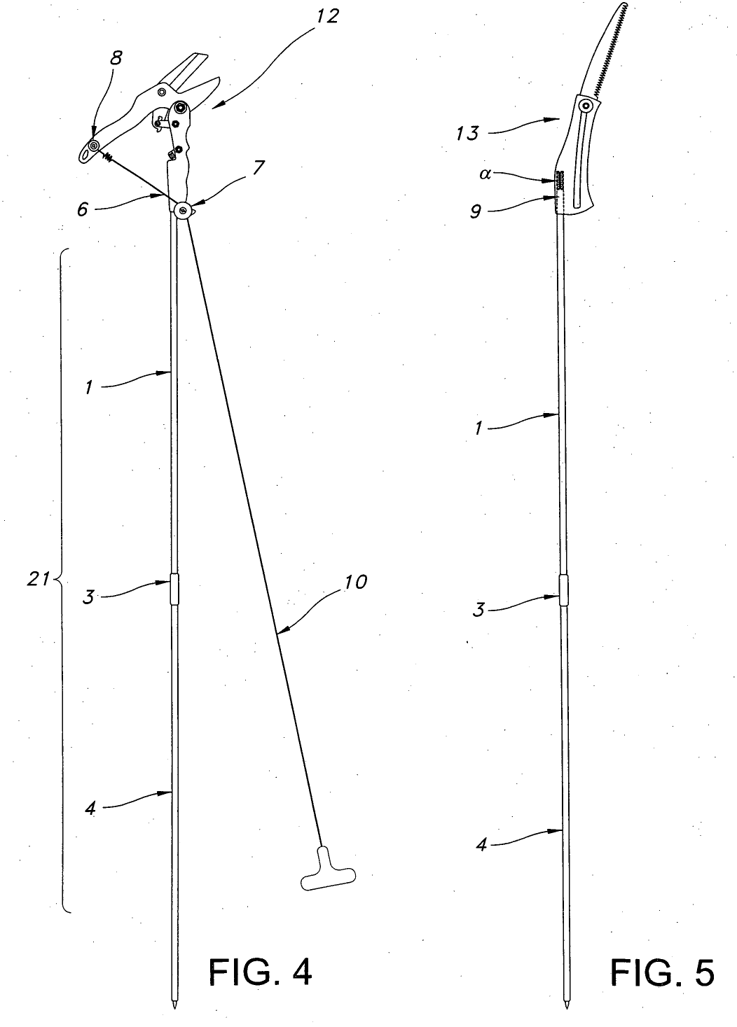

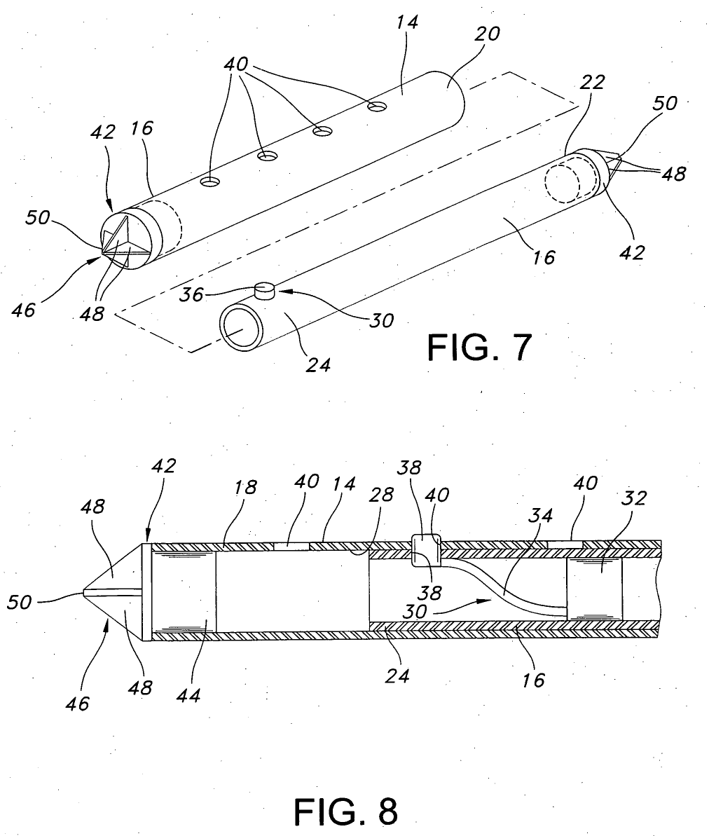

In the present invention, each of the slender extension shaft segments can be assembled together according to various different configurations. According to a first embodiment, we envision that the extension member has a rather simple design, in which one could manually assemble the shafts segments of the extension in short order. In such a configuration, a first segment of an extension segment or member has a first end that can be fitted to engage with an opposing counterpart end, or second end of a second segment, as shown in FIG. 4 or 5. The first and second ends, each, will have a connector device, for example, such as a bolt or screw, which can be applied to a counterpart connector, such as a receiving recess or hole. Each part of the entire connector system may have grooves, threads, or some other mechanism that will engage or interlock the several segments together to ensure a secure joining. The attachment mechanism, for example, may include a pairing of a male-threaded bolt and a female-threaded sleeve. Other variations may employ, for example, spring or ring clamps, pins, tightening screws, compression fittings or locks, crimp-fittings, hooks, interlocking flanges and grooves, or other detachable mechanisms to securely fasten two adjacent segments together. These mechanisms can be situated along a side of the shaft near the engaging end of each of the segments, and can be either fitted together into corresponding grooves or slots along the shaft body, or tightened or turned to lock the segments. FIGS. 7-9 illustrate two types of workable attachment mechanisms, which will be further elaborated upon below.

The individual shaft segments can have either a solid, hollow, or partially solid and/or partially hollow core construction. In some hollow-core embodiments, the shaft segments can be stored as a bundle of tubular shafts. An elastic or shock cord, such as a nylon or bungee cord, which exhibits tension and compression, ties the individual segments together, end to end. The cord can extend through each segment, or run through conduit channels. The cord can be attached at the outer ends of the terminal segments. Once a force is applied, the individual segments of the extension rod will straighten out of the bundle and largely self-assemble and interlock into a longer pole, such as exemplified in some types of walking canes used by sight-impaired persons, or embodied in extendable magic wands. To illustrate, for instance, the extension pole be stored in a disassembled state in which a number of individual segments are folded side-by-side, like a bundle of sticks. With a jarring or shake of the folded segments, the pole can reassemble itself. The tension of the elastic cord can draw or pull the segments into alignment of a straight rod. The respective ends of each of the individual segments can self-lock with the end of its opposing segment, or the ends each can be manually tightened together to create a sturdy extension pole.

Alternatively, a larger pole can be pieced together manually. The user may only need to tighten bolts or screws or fittings to lock the segments. In other embodiments, the individual segments of the rod can be nested within one another, such that individual tubular or cylindrical segments have sections that overlapping at least in part, and can be made to slide in or out, with adjustable lengths for a telescopically configured rod.

According to certain embodiments, the shaft segments can have physical dimensions similar to the shafts of hunting arrows, which are relatively light weight—typically no more than a few pounds. Accordingly, such segments are well adapted for storage and transport in an arrow quiver-like case. Depending on the desired length and thickness, the assembled extension rod 21 can be the length of a single arrow shaft, or a number of shaft segments integrated together end to end.

The rod member is substantially straight and rigid or semi-rigid. The shaft of the extension rod should be strong and of sufficient rigidity to not bend or droop significantly under the weight of the attached tool, or from torsion forces generated by the tool during use when it is attached to the rod member. In certain applications, the material should be flexible to prevent the shaft from snapping under the stress force load. Often times, in other embodiments, the shafts should be rigid and not bend. According to the invention, each shaft segment desirably is constructed of rigid to semi-rigid materials that exhibit a property of being able to return to the shaft's original configuration after a stressing force has been removed from acting upon the material, which is referred to as having “original memory.” That is, the shaft will return substantively to its original unbent configuration and not become permanently deformed from use.

The shaft of the extension rod segments can be fabricated from a variety of either rigid or semi-rigid materials, such as used for fishing poles and golf clubs. The shaft of the extension should be strong, durable, and does not bend excessively from the weight of the cutting tool when the extension shaft is assembled and cantilevered away from the operator in use. According to the invention, the shaft of the extension flexes and does not break when subject to a shearing or twisting stress. Referring to the accompanying figures, which shows that the shaft segments can be composite tubular articles, such as archery arrow shafts, golf club shafts and fishing rod bodies. As used herein, the word “tubular” includes any shape that is symmetrical about an axis of rotation and is not limited necessarily to elongated cylindrical forms, such as golf club shafts or fishing rods.

Such materials may include conventional materials, such as wood, polymer plastics, aluminum, light-weight steel, titanium, or other metals or metal alloys. Examples of some moldable organic polymer plastics may include nylon laminates, polyolefins (e.g., polybutylene, polypropylene, and their copolymers), polyesters, polyethylene terephthalate (PET), etc. In certain embodiments, fiberglass or carbon fiber-based materials are desirable for constructing the shaft of the extension pole. Considering the factors of weight, torsion or bending strength, however, some kinds of thermal polymer plastics, fiberglass, epoxy resin-reinforced fibers, carbon fiber nanotubes, Kevlar® or Teflon® materials (DuPont), or composites and laminates of like materials may be more preferred. For instance, in some commercial embodiments, the shaft segments of the extension rod can be made from rolled or wound laminated sheets of fiberglass, carbon-fiber, epoxy-reinforced fibers, polyolefins, or nylon. Other examples of some suitable materials and techniques for fabricating the present extension shafts may include, configurations such as described in U.S. Pat. Nos. 5,188,872 (Re-issue No. 35,081) (detailing a tubular composite structure); 5,397,636; 5,795,524; 6,454,691; U.S. Patent Publication Nos. 2004/0031952 A1; 2004/0089404 A1; 2004/0092330 A1; 2004/0214007 A1; or International Patent Publication No. WO96/24413 A1, the pertinent contents of which are incorporated herein by reference.

In certain embodiments, the core of each segment of the shaft may be reinforced with a rigid mandrel either on the inside of a hollow shaft or over the outside of a solid shaft. The mandrel material can be made from a strong, yet lightweight, inorganic, polymeric, or metallic materials. Further, the semi-rigid material may be a unitary piece or of segmented pieces; segmented pieces are shorter and may be joined by an elastomeric cord for convenience when folding or they may be telescopic so one segment slides into another for storage. The ends also may be attached to each other by a hinge mechanism which straightens in use and folds for easily assembly or disassembly and storage.

In a kit, the individual shaft segments can have different lengths and widths. This can permit the user the freedom to customize the overall length and width for a particular purpose or application. For instance, a wider tapered segment joined with a slimmer segment might provide greater control of the rod. The outside surface of the shaft segments may have a number of ridges, knurling, or fluting that run circumferentially and either longitudinally or across the length of the segment, to enhance grip by the user.

According to an embodiment, the present extension rod may be made from modified arrow shafts, that are both lightweight and exhibit a high degree of torsion strength. A number of arrow shafts can be joined together, such as illustrated in FIGS. 1 and 4, in an elongated axis. The arrow shafts should be both flexible, to bend under tension without breaking, as well as rigid, such that the elongated rod does not sag under its own weight nor the weight of the selected tool that one attaches to the remote end. Arrow shafts are used by archers. The present invention will provide the sportsman, especially bow-hunters, with extended pruning capability using standard hunting components without adding excess bulk, heavy equipment to transport to and from the hunting area. The present invention is particular adapted, for example, as a pruning device for trimming limbs either from the ground or, especially, from an elevated position.

To illustrate a use of the present invention, an extension mounted pruning tool can be assembled first by fitting together the overall extension rod 21 from the number of shorter individual rods. The actual number of shafts that make up the tool depends on the overall desired length of the assembled extension pole. Each shaft can be have a length of about 6-8 inches up to about four or five feet, with a diameter of up to about 2 inches. In certain embodiments, such as those constructed from arrow shaft materials, typically, a shaft is about two to three feet in length, with a diameter between about 0.25 inch to about 1 inch (˜2.5 cm).

The extension shaft should have a weight that does not exceed a few pounds, and the entire assemblage should have a weight of not more than about 10-12 or 15 pounds. More particularly, the individual extension shaft segments weigh from about 6-8 to 10-12 ounces, and the assembled rod does not exceed about four or five pounds. The lighter the weight of the extension shaft, the more it is preferred.

Illustrative of the general invention, the example depicted in the accompanying FIGS. 1-6, show an embodiment in which each individual shaft segments can have both a male bolt and a female receptacle at opposing ends of a segment. Each of these connectors can be configured to have complementary screw threads. From FIG. 1, 4, or 5, the two extension rod segments 1, 4 are joined together end to end, by inserting a male threaded stud 5 into female receiving sleeve 3. The cutting tools 12, 13 are connected and mounted to shaft segment 1, of the extension rod 21 when a male threaded screw or bolt, (e.g., 8/32″ or 10/32″ steel threaded stud) is inserted to either receiving sleeve 6 on the ratcheting clipper 12, or slot 9 in the handle of saw 13, respectively. Hence all of the parts of the kit can be joined easily together by screwing one into the other at the ends of the individual segments.

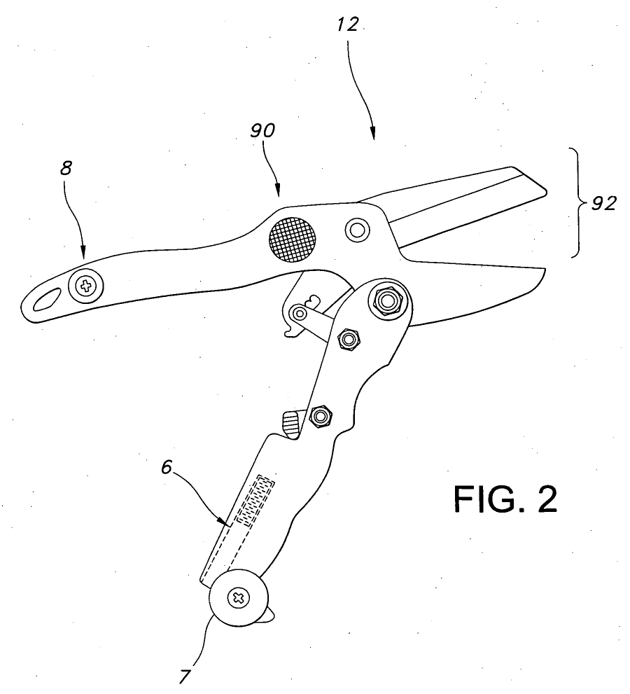

FIG. 2 illustrates a side view of a hand-operated ratcheting anvil-style clipper, such as those available from FISKARS BRANDS, INC., Madison, Wis. A ratcheting anvil pruning clipper has an engaging member having a base portion and an upper portion with a configuration defining a downwardly directed gripping region adapted to fit a limb or vegetation to be severed between the two portions. The ratcheting anvil pruning clipper further has a cutting member having an upper blade and a lower stationary plate, the cutting member being pivotally joined by a ratcheting mechanism at a site proximal to the blade and stationary plate, such as to the rear of the blade. According to the invention, the clipper is modified with a recess 6 located inside part of the handle. The recess is adapted to receive the terminal end of the extension pole 1. According to the embodiment in FIG. 2, the recess has a female-threaded sleeve that is permanently connected to the end region of the lower handle of the ratcheting anvil clipper. A tether stud 7, situated and connected to a side of the lower handle of the ratcheting anvil clipper, receives and secures a tether line 10. Tether stud 8, situated on a side of the ratcheting anvil clipper's upper handle connects with tether line 10. When the assembly is extended, the tether line 10 enables an operator to pull the line with a force toward the lower extremity 4, thus engaging the ratcheting mechanism of the clipper. This action causes the upper handle of the clipper to move down toward the lower handle, closing the cutting blade, and severing limb or foliage between the cutting blade and its opposing anvil. In other words, the tether means secured to the upper handle and running underneath the tether stud secured lower handle of the ratcheting anvil pruning clipper should have sufficient length to extend a free terminal extremity below the lower extremity of the shaft segment. Hence, a pulling motion applied to the tether produces a forward ratcheting traversal of the blade portion through to the cutting plate region. One can then restore the ratchet mechanism for further cuts.

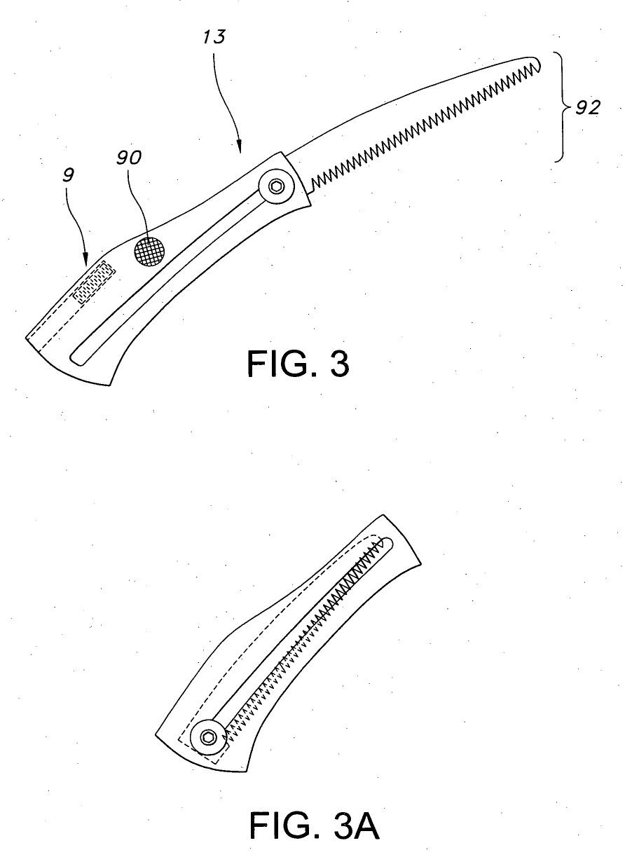

FIG. 4 shows an embodiment of the present invention with the ratcheting anvil clipper mounted atop of shaft segment 1, demonstrating the various components assembled together to achieving device for extend pruning of limbs and foliage. As depicted, applying a pulling force to the tether line one easily can operate the ratcheting anvil-pruning shear from an elevated position such as a hunting tree stand, without fear of loosing balance while handing a large conventional pole trimmer. FIG. 5 shows a variation with an alternate cutting tool, namely a saw, as shown in FIG. 3, attached and mounted to the end of the extension pole in like fashion as the pruning clipper, mounted atop shaft segment 1, for achieving extend sawing. A female threaded sleeve 9, either permanently formed in or connected to a part of the handle of the saw can receive the terminal end 2 of the extension pole 1. One can grip the extension rod at a lower portion and perform a sawing, push-pull motion.

Another use of the present extension rod can be to help a sportsman balance or carry a package of gear or other equipment over his shoulders. With the extension pole fully extended, a load can be attached to each end of the pole for easy carrying. The present extension pole is designed to be able to withstand a weight of up to about 25 or 30 pounds. Typically, an amount of force of about at least 8-10 lbs. of pressure applied to a ratcheting pruner or saw. The upper end of the shaft can permit the attachment of a pulley or fulcrum system to operate the cutting tool. The present invention will provide a hunter with extended pruning capability using standard hunting components without adding excess bulk, heavy equipment to transport to and from the hunting area.

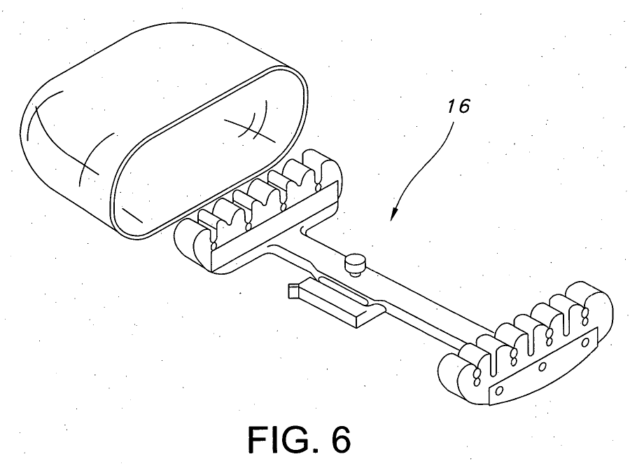

In certain examples, the extension rod segments can be constructed from modified hunting arrow shafts that typically have a length of about 20-40 inches, typically about 24-36 inches. The shaft or mandrel can have a diameter of up to about 1.85 or 2 inches (˜3-4.5 cm). Typically, the diameter is between about ¼ inch to about 1.5 inches. In preferred embodiments the shaft diameter is does not exceed about 1 inch (˜2.2-2.5 cm), and desirably the same diameter about ½-⅝ of an inch, like that hunting arrows. Generally, arrow shafts used by archers are relatively light. Typically, each segment weights no more than a few ounces (e.g., 2-5, sometimes 10-16 ounces). According to an embodiment, with a weight and physical dimensions similar to those of arrow shafts, each shaft segment can easily fit within sized clips or slots of a quiver-like case or package, such as illustrated in FIG. 6, for convenient transport and storage. This type of embodiment is generally suited for hunters and campers, and would fit well with the existing hunting gear of bow hunters in particular.

The particular example of a storage case depicted in FIG. 6 shows places for up to four extension shaft segments. Depending on the specific design, other examples may have more or less slots. For instance, some designs may allow for as few as two, to as many as 8, 10, 12, 20, 24, or more extension shafts to be stored together in a case.

Ideally, the extension pole can be as long as the user desires; or in other words, the pole should be configured to enable the user to reach his desired target. In practical terms, however, the overall length of an assembled extension pole is limited only by the properties of the material from which the rod is made. The amount of flex and the torsion strength of the shaft material should counteract the tendency of the shaft to bend under the weight of the cutting tool when it is cantilevered out, away from the user. Hence, a material that is more rigid is more likely to enable one to construct a longer pole with more reach than a more flexible material. Typically, a fully assembled extension pole can be as long as several feet, for example about 8-10-12 feet. More typically, the assembled pole is between about 5 to 7.5 feet in length.

In other embodiments and variations, it is envisioned that the present tool can include a knife, ax or other kind of cutting blade for field-dressing an animal. The cutting blade is suitably modified or adapted to have an attachment mechanism that enables it to be mounted stablely to the extension rod. After a game animal is taken, the animal is typically field dressed, which involves skinning the animal, opening the body cavity of the animal and removing the internal organs, and preparing the carcass for butchering. One can attach a knife to one end of the extension rod, in a manner similar to that described and illustrated in FIGS. 4 and 5 for the ratcheting pruner and saw, respectively. Once mounted, the extension mounted knife can enable the hunter to field dress the animal without having to envelope his arms and upper torso in the body cavity to access normally hard to reach areas of the animal interior, such as the upper chest and neck regions of a deer carcass. Conventionally, a hunter would incur a great mess. The extended reach of the extension rod will allow the hunter to easily place and maneuver the knife in the deeper parts of the animal's carcass, removing the entrails, without getting much of it onto his own body or clothing. Some hunting blades that can be adapted to allow the extension rod to join with a slot or groove made in the handles of the blades, may include, for example, those described in U.S. Pat. Nos. 3,445,931, 3,791,033, 5,033,987, 5,581,895, 5,845,404, or 6,598,298, and/or Patent Publications No. 2002/0104222, the contents of which are incorporated herein.

In certain embodiments, it is envisioned that a light emitting diode (LED) may be incorporated as part of the present device. The LED can be associated with either the extension rod member or the tool, such as on the stalk or handle of a clipper, saw, or knife. As illustrated in FIGS. 2 and 3, the LED 90 can be attached at a particular spot near the operating end 92 of the tool by various means, such as a hook and loop system (e.g., Velcro®), an adhesive, or clip. Alternatively, the tool can be customized with a built-in LED, or the LED can also be attached to the surface of the extension rod near where the tool is mounted.

An LED can be very helpful. Hunters often go out to hunting sites in the early morning before sunrise. The presence of an LED can help the hunter more easily see what is he doing by illuminate the area at the working or active-end of the extension rod and tool. For field-dressing applications, an LED situated on the handle of a dressing knife or blade, can better illuminate the abdominal or thoracic body cavity of the animal. This can help the hunter remove all of the vicera and avoid accidentally piercing or puncturing the viceral linings during the butchering process.

In hollow rod designs according to embodiments depicted in FIGS. 7-11, the two segments of the extension pole can include a first or outer member 14 and second or inner member 16. As in FIG. 7, the second or inner member 16 is sized such that it fits and slides in a reciprocal manner within the first or outer member 14 in a telescopic relationship. According to the embodiment, a series of holes on one segment allows a corresponding button on the other segment to form an adjustable locking system when the button is inserted into a hole. The length of the extension can be adjusted by moving the inner member in or out of the outer member. The cross-sectional geometry of the extension pole is not limited to any particular shape or configuration. That is, the cross-section profile can take the form either of a largely circular, oval, square, triangular, hexagon or other polygonal shape, as long as the shape of the extension pole can be easily and comfortably gripped in hand. Preferred embodiments have a circular cross-section profile. As illustrated in accompanying figures, both the outer 14 and inner 16 members are cylindrically shaped tubular members wherein the inner member 16 slidably fits within the outer member 14. The first or outer member includes an engagement end 18 and a receptacle end 20. The second or inner member 16 also includes an engagement end 22 and a leading end 24. As illustrated, the leading end 24 of the inner member 16 is inserted into the receptacle end 20 of the outer member 14. Accordingly, as the inner member 16 slides within the outer member 14, the overall length of the extension pole 15 will vary.

A detent mechanism, seen generally at 30, is used to secure the respective inner 16 and outer 14 members to one another and to maintain the desired overall length of the extension pole 15. As shown herein, the detent mechanism 30 includes a support member 32 inserted within the leading end 24 of the inner member 16. A spring arm 34 attaches to the support member 32 and has a button 36 located on one end thereof. It should be understood that the spring arm 34 provides the necessary bias to urge the button 36 outwardly through an aperture 38 in the leading end 24 of the inner member 16. Other mechanisms which operate to urge the button 36 outward through the aperture 38 also come within the scope of the present invention.

As illustrated in FIG. 7, the outer member 14 includes a plurality of apertures 40 located longitudinally thereon. These apertures 40 form a part of the detent mechanism 30 in that they cooperate with the button 36 to secure the position of the outer member 14 with respect to the inner member 16. To adjust the overall length of the extension rod 21, the button 30 is depressed or pushed inward until it is below the inner surface 28 of the outer member 14 and thus the outer member 14 is disengaged and uncoupled from the inner member 16 and the inner member 16 is free to move within the outer member 14. Accordingly, the respective outer member 14 and inner members 16 may be repositioned, after which the button 36 is released and allowed to extend outward through the nearest aperture 40 on the outer member 14 to engage and couple the outer and inner members 14, 16.

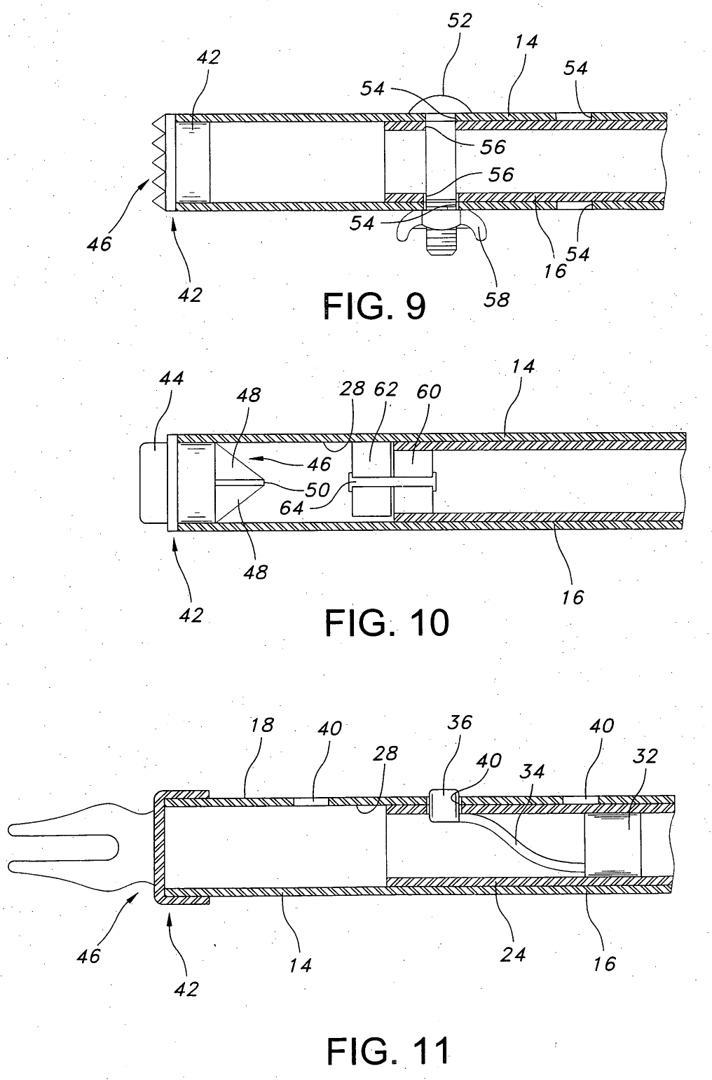

FIGS. 9-10 show further embodiments of detent mechanisms suitable for use with the present invention. FIG. 9 shows a threaded fastener 52 extending through apertures 54, 56 in the outer 14 and inner 16 members. A nut, such as a wing nut 58, engages the threaded fastener 52 to secure it in place. FIG. 10 shows a twist/cam lock type detent mechanism 30 having a support member 60 and a cam 62 secured for rotation on the support member 60 by a pivot pin 64. As the inner member 16 is axially rotated it causes the cam 62 to rotate and engage the inner surface 28 of the outer member 16 and creates a wedge or binding force which locks the respective outer 14 and inner 16 members in position. It should be understood that any detent mechanism 30 which operates to secure the outer 14 and inner 16 members in position, comes within the scope of the present invention.

In other embodiments, the kit may include a number of different types of end caps 42, each being interchangeable as the need may require. For instance, end caps designs or configurations can have a small field-point or spike to secure the extension shaft when it is stuck into the ground, or a dentated or knurled configuration, to engage with the either the ground or some other surface and prevent the extension rod from slipping or moving, such as when leaned against a vertical wall surface or the like, or a rubberized stopper, such as illustrated in FIGS. 9 and 10, respectively. Another design may have an arrow knock or a pulley hook can be attached to a terminal end of the extension shaft to help guild the tether line or other lines, such as shown in FIG. 11. In such a situation, it is envisioned that when angling with a hook or grapnel, one can use a gear line or cord of relatively low friction can be threaded between the prongs of the arrow knock and used to control the line, like a puppeteer, to pick up objects. This application can be useful for both when a hunter is in his hunting perch or a fisherman in his boat to bring up or retrieve objects such as clothing or equipment. The arrow knock, depending on its size and construction (e.g., smooth metal or steel, or polymer plastic), can accommodate a rope of typically about ⅛ inch standard line, and can help pull up an object with a weight of up to about 10-25 or 30 lbs.

As shown in FIGS. 7 and 8 the extension pole 15 further includes end caps 42 placed on the respective terminal ends 18, 22 of the outer 14 and inner 16 members. The end caps 42 may take various configurations. As shown in the present embodiment, the end caps 42 included a reduced diameter post portion 44 sized to fit within the engagement ends 18, 22 of the outer 14 and inner 16 members. The end caps 42 further include an engagement portion 46 having a non-slip surface or configuration. The engagement portion 46 shown in FIGS. 7 and 8, includes a plurality of inclined plate-like members 48 extending outwardly and forming a pointed end 50.

It should be understood that the end caps 42 may have a variety of engagement portion 46 configurations as long as they operate to prevent the extension pole from slipping or moving. As shown in FIG. 9, the engagement portion 46 may have a knurled configuration. Further, in FIGS. 8-10 the end caps 42 are shown inserted within the engagement ends 18, 22 of the outer 14 and inner 16 members, however as shown in FIG. 11, part of the end cap 42 may have a cup shape and be placed over the respective engagement ends 18, 22 of the respective outer and inner members 14, 16. As shown in FIG. 10, the end caps 42 may be reversible, in that the engagement portions 46 are inserted within the outer 14 and inner 16 members, prior to use. Wherein the post portion 44 of the end caps 42 extends outward. Prior to use, the engagement portion 46 of the respective end caps 42 is withdrawn from within the respective outer 14 and inner 16 members, the end cap 42 is reversed or rotated, and the post portion 44 is inserted into the engagement end 18, 22 of the outer 14 and inner 16 member. This enables the engagement portion 46 to remain within the rod during transport and prior to use thus reducing the likelihood of it snagging or catching on the hunters clothing or gear during transport. Finally, the end caps 42 can be made of any material suitable to provide a non-slip surface or configuration.

According to another application of the present assemblage, fishermen can use the extension kit as a tool for retrieving lures. Often when either casting a fly or reeling in the line, fishermen can catch or snag their fishing lines and lures in overhead tree branches and other vegetation on land, or submerged limbs and rocky crevices in the water. These kinds of accidental entanglements can be quite costly. Often once entangled, fishermen find that it can be difficult, if not impossible, to disengage their lines and are often forced to cut or break the line. Typically this means that the fisherman would risk loosing the fishing lures, which can be rather expensive. With the present invention a fisherman can disentangle the line by either cutting the vegetation free, or use the long reach of the extension pole to pick the lure and line free. The extended reach can also allow fishermen to reach into shallow shoals, rocks, or underwater snags that may prevent them from maneuvering close in because of the widths or drafts of their boats.

At the terminal tip of the extension rod, opposite the attachment for the tool, according to some embodiments may have a fastener, such as an arrow knock, for holding a rope or string line. The fastener can permit one to control the tension and slippage of the rope line can allow one to retrieve items from a distance. For example, once a bow hunter is situated on his shooting platform in a tree, he will need to transport his gear, such as bow, gun, pack, or clothing from the grown to the level of the platform. Like a cantilevered crane or fishing pole, one can use a grapple hook attached to the end of the rope line can be used to lift the gear up to the platform level. The opposing end of the lower part of the shaft segment can be weighted for counterbalance in some embodiments. A weighted end cap can be inserted for this purpose.

In other uses, a pincer or grasping mechanism that can be operated remotely, such as by means of a tether line, pulley, or some form of trigger can be attached to the end of the extension pole to permit one to pick out objects, such as a fishing lure, from the branches of a tree or the weeds of a lake or stream.

Alternatively one can use the extension mounted tool to prune or pick items that are out of reach or in poisonous plants or nettles. As an illustration of one of the benefits of the present invention, when out in the woods, campers or outdoorsmen sometimes need to trim back bushes, shrubs, or small tree limbs. This may involve preparing a trail, clearing for a campsite or hunting blind. Sometime one may not wish to actually touch with one's hand, even gloved, things like a thorny bush or a poison plant, such as poison ivy, oak, or sumac. One can use the present invention to remove or trim the offending vegetation from a safe distance, for example, as far as about 10 or 12 feet away.

For sportsmen out camping, who may need to reach a source of water, such as, a cascade, river or stream, without being able to approach the water too closely because of rocks or a steep bank, for instance, a cup or ladle attachment can be employed with the extension rod to reach and convey water sources. (Of course the ladle can be used to collect any kind of liquid.) Alternatively, one may also have a sieve attachment to strain a liquid. The ladle or sieve attachment can be fastened to an end of the extension rod in like manner as the saw or clipper already illustrated, according to any of the attachment mechanisms already described, such as a screw or bolt insert, a fastening bolt, or friction-fit clamps.

Another perennial concern for hunters is scent. Manipulation of vegetation for camouflage or other purposes often can leave human scent in the area, which wards off potential game animals from the area of the hunter. For instance, white tail deer have an excellent sense of smell. Deer normally will not approach an area with strong human sent. By using the present extension assembly, another advantage is that one can remove or manipulate foliage from a distance without leaving a human scent trail or “fingerprint,” which game animals may pick up. Since the person is a short, remote distance (e.g., 2-5 meters) away from the activity or immediate affected area, virtually no sent is left behind on the standing vegetation or ground.

The present invention is environmentally friendly. Hunting generally occurs in rural areas with open fields or areas where there are sizable, large or continuous stands of trees and brush. For example, some hunting ranges are on commercial timberlands. In the past, to create clear shooting lanes, hunters would chop down trees. Since the hunter often does not own the land upon which he hunts, cutting and damage of trees often is a source of friction between the hunters and landowners. The present kit will allow many trees to be saved. Hunters who formerly would have cut down an entire tree to create shooting lanes, now, instead, by using the present invention are able to make only minor pruning or trimming to obstructing branches and limbs of bushes and trees. This is beneficial to both the hunter as well as the landowner by lessening the human impact to trees.

Although the present invent has been described in the context of sportsmen's equipment, the present invention are not necessarily limited to hunting or fishing functions. Various alternative functions are also envisioned. For instance, the present invention can be easily adapted to gardening or horticultural uses. The present invention provides a kit assembly, that almost any homeowner, gardener or landscape architect will find useful in view of the need for a relatively light weight, elongated pruning or trimming device on a supporting extension shaft. In addition to being able to trim a twig or pick out a fishing lure, both rather delicate operations, the device can be useful for, such other delicate activities as pruning a rose bush without being stuck by immediately surrounding thorns.

The present invention has been described generally and in detail by way of the figures and examples of preferred embodiments. Persons skilled in the art, however, can appreciate that the invention is not limited necessarily to the embodiments specifically disclosed, but that substitutions, modifications, and variations may be made to the present invention and its uses without departing from the scope of the invention. Therefore, changes should be construed as included herein unless they otherwise depart from the scope of the invention as defined by the appended claims and their equivalents.

I claim:

1. A multipurpose assembly comprising: a) a compact extension rod formed of either one or a plurality of joinable individual shaft segments, and each of said shaft segments having physical characteristics of an arrow shaft, and b) an interchangable tool adapted for either cutting or trimming vegetation, field-dressing game, retrieving an object from a distance, or collecting a liquid, attached to an end of said extension rod.

2. The assembly according to claim 1, wherein a first send of a first shaft segment has a first adaptor for engaging with said tool, and a second end of a second segment has a second adaptor for holding a terminal insert.

3. The assembly according to claim 1, wherein said tool is selected from at least one of the following: a cutting or trimming device, pincers or tongs, pliers, ladle, sieve, and hook or grapnel.

4. The assembly according to claim 3, wherein said cutting or trimming device is either a ratcheting anvil-pruning clipper, shears, saw, knife, or hand-ax blade.

5. The assembly according to claim 2, wherein said terminal insert is an end cap according to one of the following: a field-point, a spike, a rubberized stopper, a fastener, an arrow knock, or a pulley hook, or an end plate having either a smooth, a dentated, or a knurled plug.

6. The assembly according to claim 2, wherein said first and second shaft segments are nested within each other to achieve a telescopically configured rod.

7. The assembly according to claim 1, wherein said assembly includes an LED device that is either built-in or attachable to said tool or part of said extension rod.

8. The assembly according to claim 1, wherein said shaft segments have the dimensions of a hunting arrow shaft, with a width to length ratio of about 1:10.

9. The assembly according to claim 1, wherein said assembly includes a quiver-like storage and transport case.

10. The assembly according to claim 1, wherein said shaft segment has either a solid, hollow, or partially hollow core construction.

11. The assembly according to claim 2, wherein said first and second segments are joined together by a connector including one of the following: a bolt, a screw, a pin, a spring or ring clamp, compression fittings or locks, crimp-fittings, hooks, or interlocking flanges and grooves.

12. The assembly according to claim 1, wherein a terminal end of a shaft segment remote from said tool is weighted for counterbalance.

13. The assembly according to claim 1, where said shaft segments have an elastic cord extending therethrough, and said shaft segments self-assemble into said extension rod when a force is applied.

14. The assembly according to claim 1, wherein said shaft segments are made from either a rigid or semi-rigid material, selected from either fiberglass, epoxy resin-reinforced fibers, polymer-based or carbon-fiber based materials, or composites and laminates of such materials, which exhibit an ability to return substantially to an original configuration when a stressing force is removed.

15. The assembly according to claim 1, wherein said individual shaft segments either are of the same length and width, or are in an assortment of variable lengths and widths.

16. The assembly according to claim 15, wherein said variable width shaft segments are adapted to engage or join end-to-end with other shaft segments of narrower or wider width.

17. A tool kit comprising: an interchangable tool adapted for either trimming vegetation, field-dressing game, retrieving an object from a distance, or collecting a liquid, secured to a first arrow-shaft-like segment having an upper and a lower terminus, by means of a connector at said upper terminus and said lower terminus having an adaptor for holding a terminal insert.

18. The tool kit according to claim 38, wherein said kit includes at least a second arrow-shaft-like segment that is joinable to said first arrow-shaft-like segment.

19. The tool kit according to claim 38, wherein said kit includes an LED device that is either built-in or attachable to said interchangable tool or part of said arrow-shaft-like segment.

20. A method of providing a multipurpose tool, the method comprises: providing a light weight arrow-shaft-like segment, with an upper and a lower extremity, said arrow-shaft-like segment formed from a substantially rigid material that can flex without breaking; attaching a tool adapted for cutting or trimming foliage or vegetation, field-dressing game, picking up an object, or collecting a liquid to said upper extremity of said arrow-shaft-like segment, and providing instructions on how to use said tool to a user.
